(19) United States
(12) Patent Application Publication
(10) Pub. No.: US 2018/0291935 A1
(43) Pub. Date: Oct. 11, 2018

(54) HYDRAULIC DRIVE SYSTEM OF CONSTRUCTION MACHINE

(71) Applicant: KAWASAKI JUKOGYO KABUSHIKI KAISHA, Kobe-shi, Hyogo (JP)

(72) Inventor: Akihiro KONDO, Nishinomiya-shi (JP)

(73) Assignee: KAWASAKI JUKOGYO KABUSHIKI KAISHA, Kobe-shi, Hyogo (JP)

(21) Appl. No.: 15/574,339

(22) PCT Filed: Apr. 28, 2016
(86) PCT No.: PCT/JP2016/002234

§ 371 Date: Nov. 15, 2017

(30) Foreign Application Priority Data
May 15, 2015 (JP) 2015-099859

(51) Int. Cl. F15B 21/14; F15B 11/10; F15B 13/02; E02F 9/22

(52) U.S. Cl. CPC F15B 21/14; F15B 11/10; F15B 13/024; F15B 13/027; E02F 9/2267; E02F 9/2275; F15B 2211/46; F15B 2211/20546; F15B 2211/41581; F15B 2211/6306; F15B 2211/6355; F15B 2211/7053; F15B 2211/20576

(57) ABSTRACT

A hydraulic drive system of construction machine includes: first and second pumps that are driven by an engine; boom control valve disposed on circulation line extending from first pump and connected to boom cylinder by boom raising supply line and boom lowering supply line; first suction line that leads hydraulic oil from a tank to first pump; second suction line that leads hydraulic oil from tank to second pump; regenerative line, through which hydraulic oil discharged from boom cylinder flows, regenerative line extending from boom control valve or boom raising supply line and being connected to at least one of the first and second suction lines; check valve provided on first suction line and/or second suction line, check valve being positioned upstream of where regenerative line is connected to first suction line and/or second suction line; and relief valve provided on relief line that communicates with regenerative line.

### TECHNICAL FIELD

The present invention relates to a hydraulic drive system of a construction machine.

### BACKGROUND ART

Construction machines, such as hydraulic excavators and hydraulic cranes, perform various work by means of a hydraulic drive system. In such a hydraulic drive system, energy regeneration is performed by utilizing hydraulic oil that is returned to a tank from an actuator.

For example, Patent Literature 1 discloses a hydraulic drive system configured to accumulate, in an accumulator, the hydraulic oil that is discharged from a boom cylinder when a hydraulic excavator lowers the boom, and assist in driving a pump by utilizing the accumulated hydraulic oil. Specifically, in the hydraulic drive system, an assist pump functioning as a motor is coupled to first and second pumps that are driven by an engine. The hydraulic oil accumulated in the accumulator is led to the assist pump.

Patent Literature 2 discloses a technique of leading the hydraulic oil that is discharged from a turning hydraulic motor when turning is stopped to a suction port of a pump. However, this technique does not regenerate energy derived from boom lowering. Moreover, in the technique disclosed by Patent Literature 2, the pump is driven by a motor generator, and energy is regenerated through electric power generation by the motor generator. Such technique cannot be applied to a configuration in which a pump is driven by an engine.

### CITATION LIST

### Patent Literature

PTL 1: Japanese Laid-Open Patent Application Publication No. 2014-145387

PTL 2: Japanese Laid-Open Patent Application Publication No. 2011-17431

### SUMMARY OF INVENTION

### Technical Problem

As described above, in the hydraulic drive system disclosed by Patent Literature 1, energy derived from boom lowering is regenerated by using the accumulator. However, the accumulator requires regular maintenance due to degradation of its inner sealed portions and lowered reaction pressure caused by leakage of filler gas.

In view of the above, an object of the present invention is to provide a hydraulic drive system of a construction machine, the hydraulic drive system being capable of regenerating energy derived from boom lowering without using an accumulator.

### Solution to Problem

In order to solve the above-described problems, a first aspect of the present invention provides a hydraulic drive system of a construction machine, the hydraulic drive system including: a first pump and a second pump that are driven by an engine; a boom control valve that is disposed on a circulation line extending from the first pump and that is connected to a boom cylinder by a boom raising supply line and a boom lowering supply line; a first suction line that leads hydraulic oil from a tank to the first pump; a second suction line that leads the hydraulic oil from the tank to the second pump; a regenerative line, through which the hydraulic oil discharged from the boom cylinder flows, the regenerative line extending from the boom control valve or the boom raising supply line and being connected to at least one of the first and the second suction lines; a check valve provided on the first suction line and/or the second suction line, the check valve being positioned upstream of where the regenerative line is connected to the first suction line and/or the second suction line; and a relief valve provided on a relief line that communicates with the regenerative line.

According to the above configuration, in a case where the hydraulic oil is discharged from the boom cylinder and the flow rate of the hydraulic oil flowing through the regenerative line is higher than or equal to the discharge flow rate of the first pump and/or the second pump at the time of boom lowering operation, the suction pressure(s) of the first pump and/or the second pump is/are kept to the setting pressure of the relief valve. Accordingly, in a case where the first pump and/or the second pump supply the hydraulic oil to another actuator (e.g., arm cylinder), energy necessary for driving the first pump and/or the second pump is greatly reduced. Therefore, energy derived from boom lowering can be regenerated. In addition, the energy regeneration can be performed with the regenerative line, the check valve(s), and the relief valve, i.e., with a simple configuration. This makes it possible to realize a highly reliable system at low cost.

The hydraulic drive system according to the above first aspect may include a regenerative switching valve that switches whether or not to allow the hydraulic oil that is discharged from the boom cylinder at a time of boom lowering operation to flow into the first suction line and/or the second suction line through the regenerative line. This configuration makes it possible to select whether or not to perform energy regeneration at the time of boom lowering operation.

A second aspect of the present invention provides a hydraulic drive system of a construction machine, the hydraulic drive system including: a pump driven by an engine; a boom control valve that is disposed on a circulation line extending from the pump and that is connected to a boom cylinder by a boom raising supply line and a boom lowering supply line; a suction line that leads hydraulic oil from a tank to the pump; a regenerative line, through which the hydraulic oil discharged from the boom cylinder flows, the regenerative line extending from the boom control valve or the boom raising supply line and being connected to the suction line; a check valve provided on the suction line and positioned upstream of where the regenerative line is connected to the suction line; and a relief valve provided on a relief line that communicates with the regenerative line.

According to the above configuration, in a case where the hydraulic oil is discharged from the boom cylinder and the flow rate of the hydraulic oil flowing through the regenerative line is higher than or equal to the discharge flow rate of the pump at the time of boom lowering operation, the suction pressure of the pump is kept to the setting pressure of the relief valve. Accordingly, in a case where the pump supplies the hydraulic oil to another actuator (e.g., arm cylinder), energy necessary for driving the pump is greatly reduced. Therefore, energy derived from boom lowering can be regenerated. In addition, the energy regeneration can be performed with the regenerative line, the check valve, and the relief valve, i.e., with a simple configuration. This makes it possible to realize a highly reliable system at low cost.

The hydraulic drive system according to the above second aspect may include a regenerative switching valve that switches whether or not to allow the hydraulic oil that is discharged from the boom cylinder at a time of boom lowering operation to flow into the suction line through the regenerative line. This configuration makes it possible to select whether or not to perform energy regeneration at the time of boom lowering operation.

In the hydraulic drive system according to the above first or second aspect, the boom control valve may include a first pilot port for boom raising operation and a second pilot port for boom lowering operation. The hydraulic drive system may include: a solenoid proportional valve that outputs a secondary pressure to the second pilot port; a pressure sensor that detects a pressure of the regenerative line; and a controller that feeds a command current to the solenoid proportional valve. The regenerative line may be connected to the boom control valve. In a case where the pressure detected by the pressure sensor is lower than a setting pressure of the relief valve at a time of boom lowering operation, the controller may control the solenoid proportional valve, such that a meter-out opening area of the boom control valve is smaller than the meter-out opening area in a case where the pressure detected by the pressure sensor is the setting pressure of the relief valve.

In a case where the regenerative line is connected to the boom control valve, the flow rate of the hydraulic oil flowing through the regenerative line is the same as the flow rate of the hydraulic oil discharged from the boom cylinder. When the discharge flow rate from the boom cylinder at the time of boom lowering operation is higher than or equal to the discharge flow rate of the pump (in the hydraulic drive system of the first aspect, the first pump and/or the second pump; in the hydraulic drive system of the second aspect, the pump), the pressure of the regenerative line is the setting pressure of the relief valve. However, the pressure of the regenerative line is substantially zero when the discharge flow rate from the boom cylinder at the time of boom lowering operation is lower than the discharge flow rate of the pump. Since the pressure of the regenerative line is substantially equal to the pressure at the meter-out outlet of the boom control valve, if no measure is taken against such decrease in the pressure of the regenerative line, the operation feeling relating to boom lowering (i.e., the boom lowering speed corresponding to the amount of boom lowering operation; the same applies hereinafter) may vary. In this respect, according to the above configuration, when the pressure of the regenerative line decreases, the meter-out opening area of the boom control valve is reduced. This makes is possible to obtain the same operation feeling relating to boom lowering regardless of the flow rate of the hydraulic oil discharged from the boom cylinder.

A third aspect of the present invention provides a hydraulic drive system of a construction machine, the hydraulic drive system including: a pump driven by an engine; a regenerative hydraulic motor coupled to the pump; a boom control valve that is disposed on a circulation line extending from the pump and that controls supply and discharge of hydraulic oil to and from a boom cylinder; a regenerative line that leads the hydraulic oil discharged from the boom cylinder to the regenerative hydraulic motor; and a relief valve provided on a relief line that communicates with the regenerative line.

According to the above configuration, when the flow rate of the hydraulic oil flowing through the regenerative line at the time of boom lowering operation is sufficient, the hydraulic oil whose pressure is kept to the setting pressure of the relief valve is led to the regenerative hydraulic motor, and thereby the driving of the pump is assisted. This makes it possible to regenerate energy derived from boom lowering. In addition, the energy regeneration can be performed with the regenerative line, the regenerative hydraulic motor, and the relief valve, i.e., with a simple configuration. This makes it possible to realize a highly reliable system at low cost.

The hydraulic drive system according to the above third aspect may include a regenerative switching valve that switches whether or not to allow the hydraulic oil that is discharged from the boom cylinder at a time of boom lowering operation to flow into the regenerative hydraulic motor through the regenerative line. This configuration makes it possible to select whether or not to perform energy regeneration at the time of boom lowering operation.

In the hydraulic drive system according to the above third aspect, the boom control valve may include a first pilot port for boom raising operation and a second pilot port for boom lowering operation. The hydraulic drive system may include: a solenoid proportional valve that outputs a secondary pressure to the second pilot port; a pressure sensor that detects a pressure of the regenerative line; and a controller that feeds a command current to the solenoid proportional valve. The regenerative line may be connected to the boom control valve. In a case where the pressure detected by the pressure sensor is lower than a setting pressure of the relief valve at a time of boom lowering operation, the controller may control the solenoid proportional valve, such that a meter-out opening area of the boom control valve is smaller than the meter-out opening area in a case where the pressure detected by the pressure sensor is the setting pressure of the relief valve.

In a case where the regenerative line is connected to the boom control valve, the flow rate of the hydraulic oil flowing through the regenerative line is the same as the flow rate of the hydraulic oil discharged from the boom cylinder. When the discharge flow rate from the boom cylinder at the time of boom lowering operation is higher than or equal to the passing flow rate of the regenerative hydraulic motor, the pressure of the regenerative line is the setting pressure of the relief valve. However, the pressure of the regenerative line decreases therefrom when the discharge flow rate from the boom cylinder at the time of boom lowering operation is lower than the passing flow rate of the regenerative hydraulic motor. Since the pressure of the regenerative line is substantially equal to the pressure at the meter-out outlet of the boom control valve, if no measure is taken against such decrease in the pressure of the regenerative line, the operation feeling relating to boom lowering may vary. In this respect, according to the above configuration, when the pressure of the regenerative line decreases, the meter-out opening area of the boom control valve is reduced. This makes is possible to obtain the same operation feeling relating to boom lowering regardless of the flow rate of the hydraulic oil discharged from the boom cylinder.

In the hydraulic drive system according to the above third aspect, the regenerative hydraulic motor may be a variable displacement motor whose tilting angle is changeable. The regenerative line may be connected to the boom control valve. The hydraulic drive system may include: a regenerative hydraulic motor regulator that adjusts the tilting angle of the regenerative hydraulic motor; a pressure sensor that detects a pressure of the regenerative line; and a controller that controls the regenerative hydraulic motor regulator, such that the pressure detected by the pressure sensor is kept to a setting pressure of the relief valve at a time of boom lowering operation. This configuration also makes is possible to obtain the same operation feeling relating to boom lowering regardless of the flow rate of the hydraulic oil discharged from the boom cylinder.

### Advantageous Effects of Invention

The present invention makes it possible to regenerate energy derived from boom lowering without using an accumulator.

### BRIEF DESCRIPTION OF DRAWINGS

FIG. 1 shows a schematic configuration of a hydraulic drive system according to Embodiment 1 of the present invention.

FIG. 2 is a side view of a hydraulic excavator that is one example of a construction machine.

FIG. 3 shows a schematic configuration of a hydraulic drive system according to Embodiment 2 of the present invention.

FIG. 4 is a graph showing a relationship between a second operation signal and the meter-out opening area of a boom control valve in Embodiment 2.

FIG. 5 shows a schematic configuration of a hydraulic drive system according to Embodiment 3 of the present invention.

FIG. 6 is a graph showing a relationship between the second operation signal and a command current to a second solenoid proportional valve in Embodiment 3.

FIG. 7 shows a schematic configuration of a hydraulic drive system according to Embodiment 4 of the present invention.

FIG. 8 shows a schematic configuration of a hydraulic drive system according to Embodiment 5 of the present invention.

FIG. 9 shows a schematic configuration of a hydraulic drive system according to Embodiment 6 of the present invention.

FIG. 10 shows a schematic configuration of a hydraulic drive system according to Embodiment 7 of the present invention.

FIG. 11 shows a schematic configuration of a hydraulic drive system according to Embodiment 8 of the present invention.

### DESCRIPTION OF EMBODIMENTS

### Embodiment 1

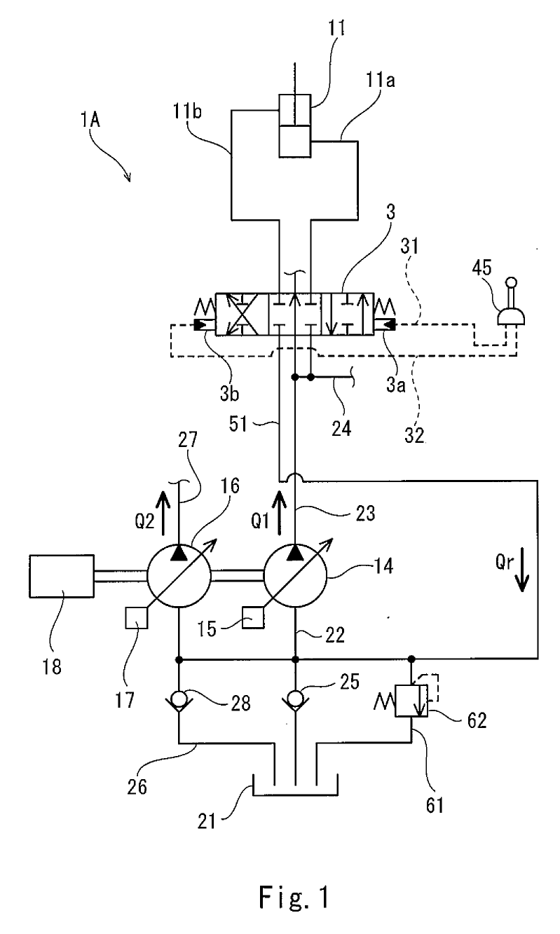

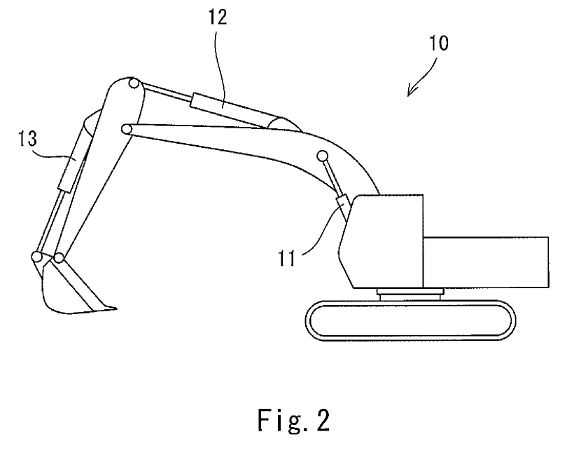

FIG. 1 shows a hydraulic drive system 1A of a construction machine according to Embodiment 1 of the present invention. FIG. 2 shows a construction machine 10, in which the hydraulic drive system 1A is installed. Although the construction machine 10 shown in FIG. 2 is a hydraulic excavator, the present invention is applicable to other construction machines, such as a hydraulic crane.

The hydraulic drive system 1A includes, as hydraulic actuators, a boom cylinder 11, an arm cylinder 12, and a bucket cylinder 13, which are shown in FIG. 2, and also a turning motor and a pair of right and left running motors, which are not shown. As shown in FIG. 1, the hydraulic drive system 1A further includes: a first main pump 14 and a second main pump 16 for supplying hydraulic oil to these actuators; and an engine 18 driving the first main pump 14 and the second main pump 16. It should be noted that, in FIG. 1, the actuators other than the boom cylinder 11 are not shown for the purpose of simplifying the drawing.

Each of the first main pump 14 and the second main pump 16 is a variable displacement pump whose tilting angle (i.e., pump capacity) is changeable. In the present embodiment, the first and the second main pumps 14 and 16 are swash plate pumps. However, as an alternative, the first and the second main pumps 14 and 16 may be bent axis pumps. The tilting angle of the first main pump 14 is adjusted by a first pump regulator 15, and the tilting angle of the second main pump 16 is adjusted by a second pump regulator 17. The discharge flow rate Q1 of the first main pump 14 and the discharge flow rate Q2 of the second main pump 16 may be controlled by hydraulic negative control, or may be controlled by electrical positive control. That is, the first pump regulator 15 and the second pump regulator 17 may operate on hydraulic pressure, or may operate on electrical signals. Alternatively, the discharge flow rate Q1 of the first main pump 14 and the discharge flow rate Q2 of the second main pump 16 may be controlled by load-sensing control.

The hydraulic oil is led from a tank 21 to the first main pump 14 through a first suction line 22, and the hydraulic oil is led from the tank 21 to the second main pump 16 through a second suction line 26.

A first circulation line 23 extends from the first main pump 14 to the tank 21 (the downstream portion of the first circulation line 23 is not shown). A plurality of control valves including a boom control valve 3 and a bucket control valve (the control valves other than the boom control valve 3 are not shown) are disposed on the first circulation line 23. The boom control valve 3 controls the supply and discharge of the hydraulic oil to and from the boom cylinder 11, and the other control valves also control the supply and discharge of the hydraulic oil to and from respective actuators. A parallel line 24 branches off from the first circulation line 23. The hydraulic oil discharged from the first main pump 14 is led to all the control valves on the first circulation line 23 through the parallel line 24.

Similarly, a second circulation line 27 extends from the second main pump 16 to the tank 21 (only the upstream portion of the second circulation line 27 is shown). A plurality of control valves including a turning control valve and an arm control valve (both of which are not shown) are disposed on the second circulation line 27. The turning control valve controls the supply and discharge of the hydraulic oil to and from the turning motor, and the other control valves also control the supply and discharge of the hydraulic oil to and from respective actuators. A parallel line (not shown) branches off from the second circulation line 27. The hydraulic oil discharged from the second main pump 16 is led to all the control valves on the second circulation line 27 through the parallel line.

The boom control valve 3 is connected to the boom cylinder 11 by a boom raising supply line 11a and a boom lowering supply line 11b. In the present embodiment, a regenerative line 51 is connected to the boom control valve 3. The regenerative line 51 extending from the boom control valve 3 is connected to both the first suction line 22 and the second suction line 26. The hydraulic oil discharged from the boom cylinder 11 flows through the regenerative line 51.

The boom control valve 3 includes a first pilot port 3a for boom raising operation and a second pilot port 3b for boom lowering operation. The boom control valve 3 is moved as a result of a boom operation device 45 being operated by an operator,

The boom operation device 45 includes an operating lever that receives the boom raising operation and the boom lowering operation. When the operating lever receives the boom raising operation, the boom operation device 45 outputs a first operation signal Sa corresponding to the inclination angle of the operating lever. When the operating lever receives the boom lowering operation, the boom operation device 45 outputs a second operation signal Sb corresponding to the inclination angle of the operating lever.

In the present embodiment, the boom operation device 45 is a pilot operation valve that is connected to the first pilot port 3a and the second pilot port 3b of the boom control valve 3 by a boom raising pilot line 31 and a boom lowering pilot line 32, respectively. That is, when the operating lever receives the boom raising operation, the boom operation device 45 outputs a first pilot pressure corresponding to the inclination angle of the operating lever as the first operation signal Sa to the first pilot port 3a. When the operating lever receives the boom lowering operation, the boom operation device 45 outputs a second pilot pressure corresponding to the inclination angle of the operating lever as the second operation signal Sb to the second pilot port 3b.

The above-described first suction line 22 and second suction line 26 are provided with check valves 25 and 28, respectively, which are positioned upstream of where the regenerative line 51 is connected to these suction lines.

The regenerative line 51 is connected to the tank 21 via a relief valve 62. Specifically, the regenerative line 51 is in communication with a relief line 61, which extends from the regenerative line 51 to the tank 21 through the relief valve 62. In the present embodiment, the relief line 61 branches off from the regenerative line 51. However, as an alternative, the relief line 61 may branch off from the first suction line 22 at a position between the check valve 25 and the first main pump 14, or may branch off from the second suction line 26 at a position between the check valve 28 and the second main pump 16.

For example, a setting pressure Pc of the relief valve 62 provided on the relief line 61 is set to 90% or less (e.g., 6 MPa) of the head-side minimum pressure (e.g., 8 MPa) of the boom cylinder 11 at the time of boom lowering operation.

As described above, in the hydraulic drive system 1A of the present embodiment, in a case where the flow rate Qr of the hydraulic oil flowing through the regenerative line 51 at the time of boom lowering operation (in the present embodiment, the flow rate of the hydraulic oil discharged from the boom cylinder 11) is higher than or equal to a sum Qt (=Q1+Q2) of the discharge flow rate Q1 of the first main pump 14 and the discharge flow rate Q2 of the second main pump 16, the suction pressure of each of the first main pump 14 and the second main pump 16 is kept to the setting pressure Pc of the relief valve 62. Accordingly, in a case where the first main pump 14 and/or the second main pump 16 supply the hydraulic oil to another actuator (e.g., arm cylinder 12), energy necessary for driving the first main pump 14 and/or the second main pump 16 is greatly reduced (at the time of boom lowering operation, the amount of energy necessary for supplying the hydraulic oil from the first main pump 14 to the boom cylinder 11 is not so great). Therefore, energy derived from boom lowering can be regenerated. In addition, the energy regeneration can be performed with the regenerative line 51, the check valves 25 and 28, and the relief valve 62, i.e., with a simple configuration. This makes it possible to realize a highly reliable system at low cost.

It should be noted that, in the present embodiment, at the time of boom lowering operation, the back pressure is kept not only at the upstream side of the boom control valve 3 (the boom raising supply line 11a), but also at the downstream side of the boom control valve 3 by the relief valve 62. Accordingly, from the viewpoint of setting the boom lowering speed to be the same as that of a conventional hydraulic drive system in which energy derived from boom lowering is not regenerated, it is desirable to increase the meter-out opening area of the boom control valve 3 to be greater than the meter-out opening area of the boom control valve in the conventional hydraulic drive system in consideration of the influence of the setting pressure Pc of the relief valve 62.

<Variations>

In the present embodiment, the regenerative line 51 is connected to both the first suction line 22 and the second suction line 26. However, as an alternative, the regenerative line 51 may be connected to only one of the first suction line 22 and the second suction line 26. In this case, the suction line to which the regenerative line 51 is not connected need not be provided with the check valve (25 or 28).

The second main pump 16 is not essential. The hydraulic oil may be supplied to all the actuators from the first main pump 14.

### Embodiment 2

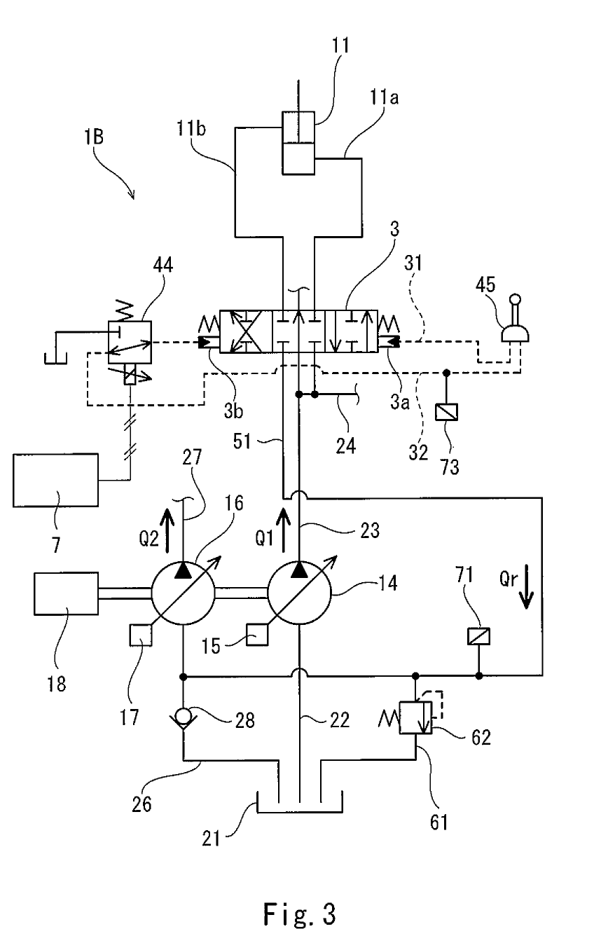

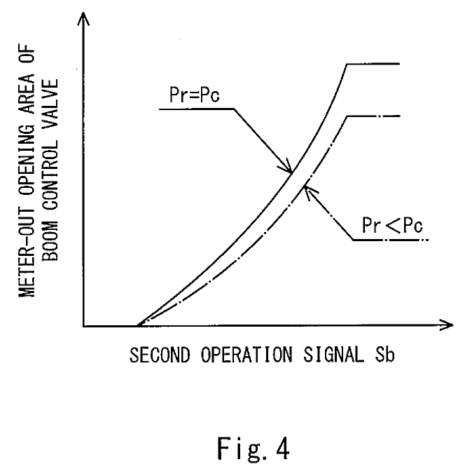

Next, with reference to FIG. 3 and FIG. 4, a hydraulic drive system 1B of a construction machine according to Embodiment 2 of the present invention is described. It should be noted that, in each of the present embodiment and the following Embodiments 3 to 8, the same components as those described in a preceding embodiment are denoted by the same reference signs as those used in the preceding embodiment, and a description of such components is omitted to avoid repeating the same descriptions.

As shown in FIG. 3, in the present embodiment, the regenerative line 51 is connected only to the second suction line 26. However, of course, the regenerative line 51 may be connected only to the first suction line 22, or may be connected to both the first suction line 22 and the second suction line 26. The same is true in Embodiments 3 to 5 described below.

When the discharge flow rate Qr from the boom cylinder 11 at the time of boom lowering operation is higher than or equal to the discharge flow rate Q2 of the second main pump 16, the pressure Pr of the regenerative line 51 is the setting pressure Pc of the relief valve 62. However, the pressure Pr of the regenerative line 51 is substantially zero when the discharge flow rate Qr from the boom cylinder 11 at the time of boom lowering operation is lower than the discharge flow rate Q2 of the second main pump 16. Since the pressure Pr of the regenerative line 51 is substantially equal to the pressure at the meter-out outlet of the boom control valve 3, if no measure is taken against such decrease in the pressure Pr of the regenerative line 51, the operation feeling relating to boom lowering may vary. The present embodiment adopts a configuration that prevents the operation feeling relating to boom lowering from varying even when the pressure Pr of the regenerative line 51 decreases.

Specifically, the regenerative line 51 is provided with a pressure sensor 71, which detects the pressure Pr of the regenerative line 51. The boom lowering pilot line 32 is provided with a pressure sensor 73, which detects the second pilot pressure (first operation signal Sa) described in Embodiment 1. The pressures detected by these pressure sensors 71 and 73 are inputted to a controller 7. It should be noted that FIG. 3 shows only part of control lines for simplifying the drawing (the same is true in the following embodiments).

The boom lowering pilot line 32 is further provided with a solenoid proportional valve 44. The solenoid proportional valve 44 is an inverse proportional valve, that is, a secondary pressure outputted therefrom and a command current I indicate a negative correlation. The solenoid proportional valve 44 is controlled by the controller 7. However, as an alternative, the solenoid proportional valve 44 may be a direct proportional valve, that is, a secondary pressure outputted therefrom and the command current I indicate a positive correlation.

In a case where the pressure Pr of the regenerative line 51 detected by the pressure sensor 71 is lower than the setting pressure Pc of the relief valve 62 at the time of boom lowering operation, the controller 7 controls the solenoid proportional valve 44 such that, as shown in FIG. 4, the meter-out opening area of the boom control valve 3 is smaller than the meter-out opening area in a case where the pressure Pr of the regenerative line 51 detected by the pressure sensor 71 is the setting pressure Pc of the relief valve 62. To be more specific, in the case of Pr=Pc, the controller 7 feeds the solenoid proportional valve 44 with no command current I, and in the case of Pr<Pc, the controller 7 feeds the solenoid proportional valve 44 with such a command current I that the pilot pressure slightly decreases.

As described above, when the pressure Pr of the regenerative line 51 decreases, the meter-out opening area of the boom control valve 3 is reduced. This makes it possible to obtain the same operation feeling relating to boom lowering regardless of the flow rate Qr of the hydraulic oil discharged from the boom cylinder 11.

### Embodiment 3

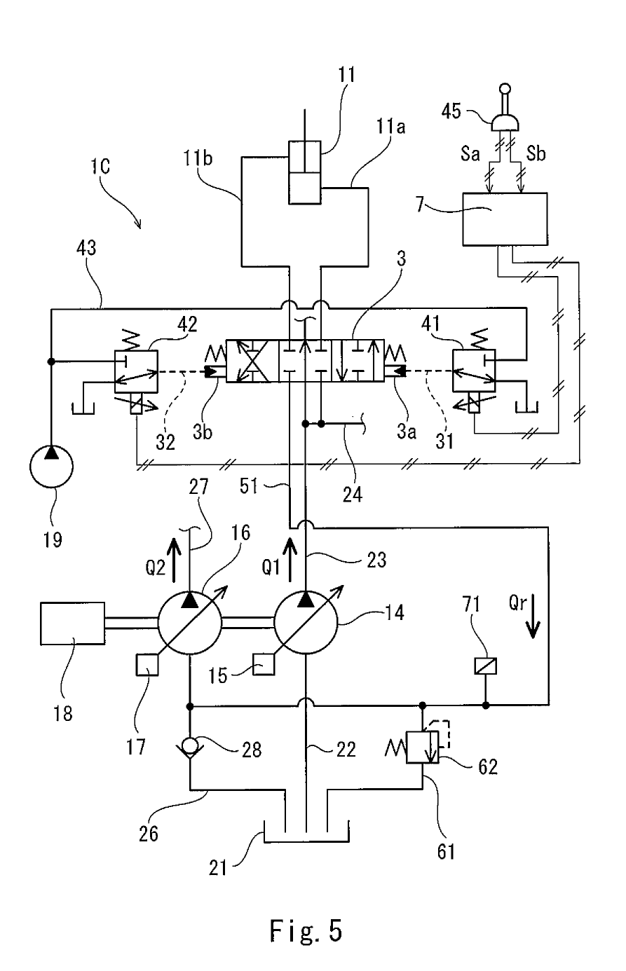

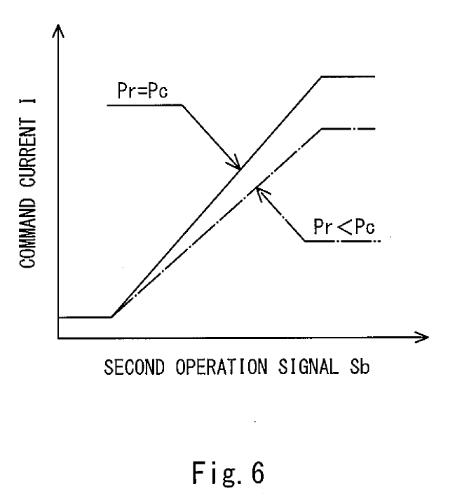

Next, a hydraulic drive system 1C of a construction machine according to Embodiment 3 of the present invention is described with reference to FIG. 5 and FIG. 6,

The hydraulic drive system 1C of the present embodiment is different from the hydraulic drive system 1B of Embodiment 2 in that, in the hydraulic drive system 1C, the boom operation device 45 is an electrical joystick. That is, the boom operation device 45 outputs the first operation signal Sa and the second operation signal Sb as electrical signals to the controller 7.

The first pilot port 3a of the boom control valve 3 is connected to a first solenoid proportional valve 41 by the boom raising pilot line 31, and the second pilot port 3b is connected to a second solenoid proportional valve 42 by the boom lowering pilot line 32. The first solenoid proportional valve 41 and the second solenoid proportional valve 42 are connected to a sub pump 19 by a primary pressure line 43. The sub pump 19 is driven by the engine 18 described in Embodiment 1.

Each of the first solenoid proportional valve 41 and the second solenoid proportional valve 42 is a direct proportional valve, that is, a secondary pressure outputted therefrom and the command current I indicate a positive correlation. The first solenoid proportional valve 41 and the second solenoid proportional valve 42 are controlled by the controller 7. When the first operation signal Sa is outputted from the boom operation device 45, the controller 7 feeds the command current I proportional to the first operation signal Sa to the first solenoid proportional valve 41, and the first solenoid proportional valve 41 outputs a secondary pressure whose magnitude corresponds to the command current I to the first pilot port 3a of the boom control valve 3. On the other hand, when the second operation signal Sb is outputted from the boom operation device 45, the controller 7 feeds the command current I proportional to the second operation signal Sb to the second solenoid proportional valve 42, and the second solenoid proportional valve 42 outputs a secondary pressure whose magnitude corresponds to the command current I to the second pilot port 3b of the boom control valve 3.

Also in the present embodiment, in a case where the pressure Pr of the regenerative line 51 detected by the pressure sensor 71 is lower than the setting pressure Pc of the relief valve 62 at the time of boom lowering operation, the controller 7 controls the second solenoid proportional valve 42 such that, as shown in FIG. 4, the meter-out opening area of the boom control valve 3 is smaller than the meter-out opening area in a case where the pressure Pr of the regenerative line 51 detected by the pressure sensor 71 is the setting pressure Pc of the relief valve 62. To be specific, as shown in FIG. 6, in the case of Pr<Pc, the controller 7 decreases the command current I fed to the second solenoid proportional valve 42 to be less than in the case of Pr=Pc. Accordingly, the stroke of the spool of the boom control valve 3 in the case of Pr<Pc is more restricted than in the case of Pr=Pc, and the meter-out opening area in the case of Pr<Pc is smaller than in the ease of Pr=Pc. Accordingly, the stroke of the spool of the boom control valve 3 in the case of Pr<Pc is more restricted than in the case of Pr=Pc, and the meter-out opening area in the ease of Pr<Pc is smaller than in the case of Pr=Pc.

The present embodiment provides the same advantageous effects as those provided by Embodiment 2.

### Embodiment 4

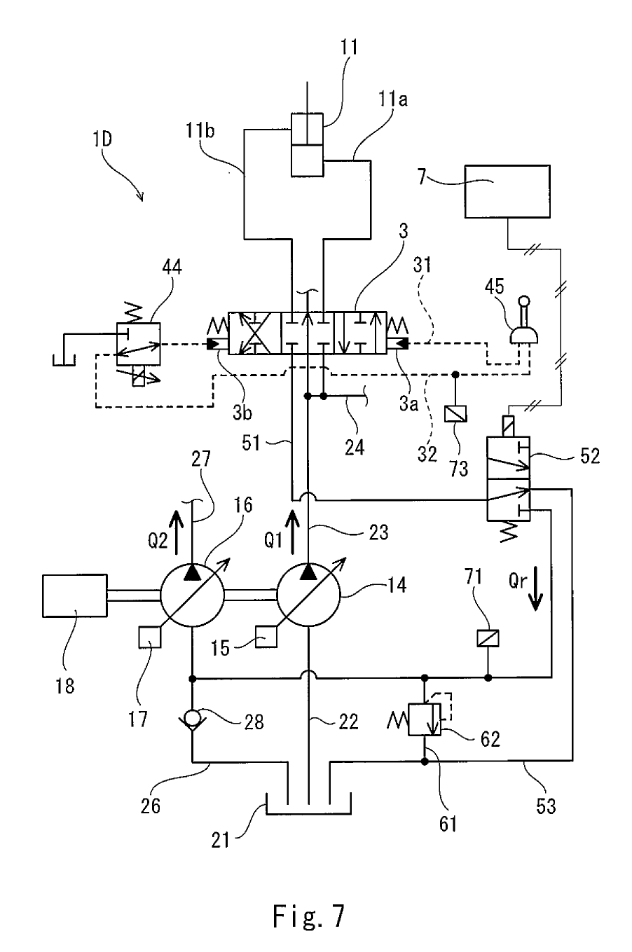

Next, a hydraulic drive system 1D of a construction machine according to Embodiment 4 of the present invention is described with reference to FIG. 7.

The hydraulic drive system 1D of the present embodiment is different from the hydraulic drive system 1B of Embodiment 2 in that, in the hydraulic drive system 1D, the regenerative line 51 is provided with a regenerative switching valve 52. A tank line 53 is connected to the regenerative switching valve 52.

The regenerative switching valve 52 is intended for switching whether or not to allow the hydraulic oil that is discharged from the boom cylinder 11 at the time of boom lowering operation to flow into the second suction line 26 through the regenerative line 51. Specifically, the regenerative switching valve 52 shifts between a non-regenerative position (lower position in FIG. 7) and a regenerative position (upper position in FIG. 7). When the regenerative switching valve 52 is in the non-regenerative position, the regenerative switching valve 52 brings the upstream portion of the regenerative line 51 into communication with the tank line 53. When the regenerative switching valve 52 is in the regenerative position, the regenerative switching valve 52 brings the upstream portion of the regenerative line 51 into communication with the downstream portion of the regenerative line 51.

The regenerative switching valve 52 may be an on-off valve that instantaneously switches its position from the non-regenerative position to the regenerative position or from the regenerative position to the non-regenerative position. However, as an alternative, the regenerative switching valve 52 may be such a variable throttle valve that at least when the variable throttle valve switches its position from the non-regenerative position to the regenerative position, the degree of communication between the upstream portion of the regenerative line 51 and the tank line 53 gradually decreases, and the degree of communication between the upstream portion of the regenerative line 51 and the downstream portion of the regenerative line 51 gradually increases. The regenerative switching valve 52 need not be a single valve, but may be configured as a pair of on-off valves or a pair of variable throttle valves.

The regenerative switching valve 52 is controlled by the controller 7 based on the second operation signal Sb (in the present embodiment, the second pilot pressure) outputted from the boom operation device 45. In the present embodiment, when the second operation signal Sb is outputted from the boom operation device 45, the controller 7 switches the regenerative switching valve 52 to the regenerative position, and when the second operation signal Sb is not outputted from the boom operation device 45, the controller 7 keeps the regenerative switching valve 52 in the non-regenerative position. By moving the regenerative switching valve 52 in this manner, the hydraulic oil discharged from the boom cylinder 11 at the time of boom raising operation does not flow into the tank 21 through the tank line 53, and thus unnecessary pressure is not generated. Therefore, in the hydraulic drive system 1D, in which energy derived from boom lowering is regenerated, loss of pump driving force at the time of boom raising operation is small.

It should be noted that the control of the regenerative switching valve 52 is not limited to the above. For example, in the case of performing the boom lowering operation, the controller 7 may keep the regenerative switching valve 52 in the non-regenerative position even if the second operation signal Sb is being outputted from the boom operation device 45. In this case, however, the pressure at the meter-out outlet of the boom control valve 3 is substantially zero when the boom lowering operation is performed. For this reason, the above-described control for preventing the operation feeling relating to boom lowering from varying needs to be adopted in the case of performing the boom lowering operation. As a result, the control algorithm becomes complex. On the other hand, if the control in which the regenerative switching valve 52 can be always switched to the regenerative position at the time of boom lowering operation is adopted as in the present embodiment, the control algorithm can be made simple.

The present embodiment makes it possible to select whether or not to perform energy regeneration at the time of boom lowering operation.

### Embodiment 5

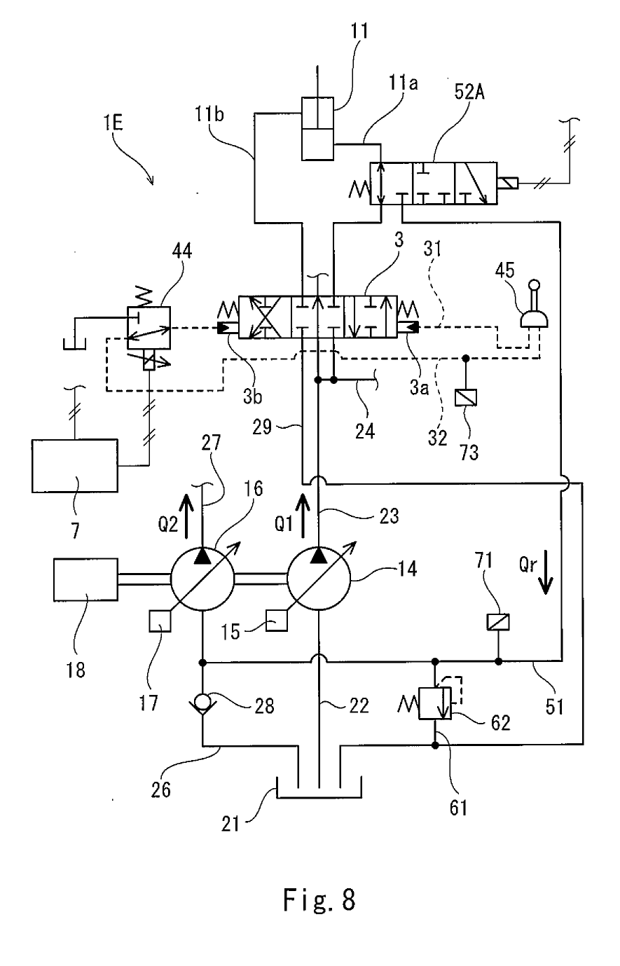

Next, a hydraulic drive system 1E of a construction machine according to Embodiment 5 of the present invention is described with reference to FIG. 8.

The hydraulic drive system 1E of the present embodiment is different from the hydraulic drive system 1B of Embodiment 2 in the following points: in the hydraulic drive system 1E, the boom raising supply line 11a is provided with a regenerative switching valve 52A; the regenerative line 51 extends from the regenerative switching valve 52A and is connected to the second suction line 26; and a tank line 29 is connected to the boom control valve 3. It should be noted that, as described in Embodiment 2, the regenerative line 51 may be connected only to the first suction line 22, or may be connected to both the first suction line 22 and the second suction line 26.

The regenerative switching valve 52A is intended for switching whether or not to allow the hydraulic oil that is discharged from the boom cylinder 11 at the time of boom towering operation to flow into the second suction line 26 through the regenerative line 51. Specifically, the regenerative switching valve 52A shifts among a non-regenerative position (left-side position in FIG. 8), a regeneration preparation position (central position in FIG. 8), and a regenerative position (right-side position in FIG. 8). When the regenerative switching valve 52A is in the non-regenerative position, the regenerative switching valve 52A brings the distal portion of the boom raising supply line 11a at the boom cylinder 11 side into communication with the proximal portion of the boom raising supply line 11a at the boom control valve 3 side, but blocks the distal portion of the boom raising supply line 11a from the regenerative line 51. When the regenerative switching valve 52A is in the regeneration preparation position, the regenerative switching valve 52A blocks the distal portion of the boom raising supply line 11a from the proximal portion thereof and the regenerative line 51. When the regenerative switching valve 52A is in the regenerative position, the regenerative switching valve 52A blocks the distal portion of the boom raising supply line 11a from the proximal portion thereof, but brings the distal portion of the boom raising supply line 11a into communication with the regenerative line 51. In the present embodiment, the regenerative switching valve 52A is a variable throttle valve that gradually increases the degree of communication between the boom raising supply line 11a and the regenerative line 51 when switching its position from the regeneration preparation position to the regenerative position.

The regenerative switching valve 52A is controlled by the controller 7 based on the second operation signal Sb (in the present embodiment, the second pilot pressure) outputted from the boom operation device 45. In the present embodiment, when the second operation signal Sb is outputted from the boom operation device 45, the controller 7 feeds an electric current of a predetermined value to the regenerative switching valve 52A to first switch the regenerative switching valve 52A from the non-regenerative position (left-side position) to the regeneration preparation position (central position) and then gradually shift the regenerative switching valve 52A to the regenerative position (right-side position) in accordance with the magnitude of the second operation signal Sb (in other words, control the regenerative switching valve 52A in an energy-regenerative direction). On the other hand, when the second operation signal Sb is not outputted from the boom operation device 45, the controller 7 feeds no electric current to the regenerative switching valve 52A, thereby keeping the regenerative switching valve 52A in the non-regenerative position (left-side position). By moving the regenerative switching valve 52A in this manner, the hydraulic oil discharged from the boom cylinder 11 at the time of boom raising operation does not flow into the tank 21 through the boom control valve 3 and the tank line 29, and thus unnecessary pressure is not generated. Therefore, in the hydraulic drive system 1E, in which energy derived from boom lowering is regenerated, loss of pump driving force at the time of boom raising operation is small.

Similar to Embodiment 4, the present embodiment makes it possible to select whether or not to perform energy regeneration at the time of boom lowering operation.

### Embodiment 6

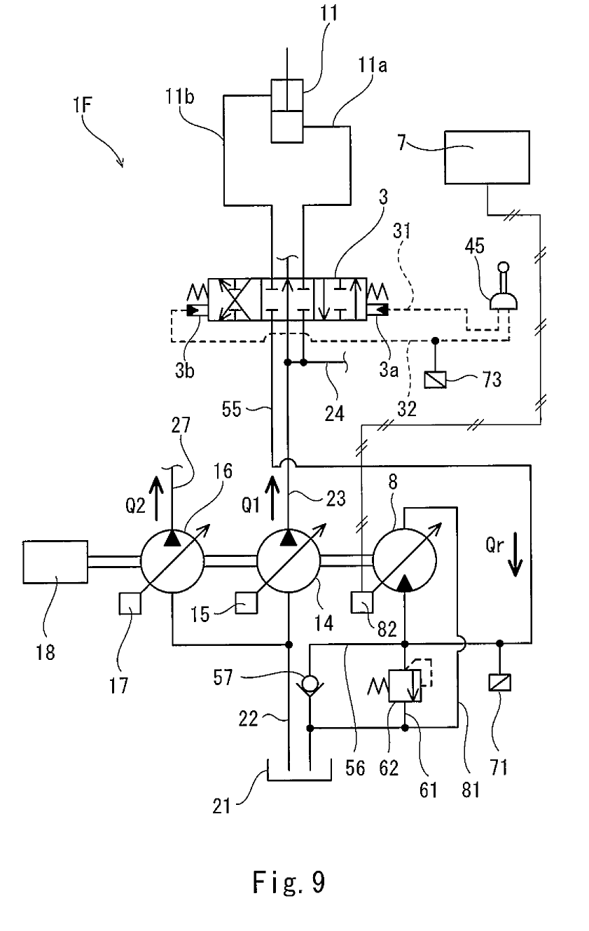

Next, a hydraulic drive system 1F of a construction machine according to Embodiment 6 of the present invention is described with reference to FIG. 9. In the present embodiment, the first main pump 14 and the second main pump 16 are coupled to a regenerative hydraulic motor 8. A regenerative line 55 extends from the boom control valve 3 and is connected to the inlet of the regenerative hydraulic motor 8. That is, the regenerative line 55 leads the hydraulic oil discharged from the boom cylinder 11 to the regenerative hydraulic motor 8. Similar to Embodiment 1, the regenerative line 55 is in communication with the relief line 61 provided with the relief valve 62. Similar to Embodiment 1, the boom operation device 45 is a pilot operation valve.

In the present embodiment, the upstream portion of the first suction line 22 and the upstream portion of the second suction line 26 merge together to form a single shared passage. However, in the present embodiment, the second main pump 16 is not essential. The hydraulic oil may be supplied to all the actuators from the first main pump 14.

A tank line 81 extends from the outlet of the regenerative hydraulic motor 8 to the tank 21. In the present embodiment, the regenerative hydraulic motor 8 is a variable displacement hydraulic motor whose tilting angle (i.e., motor capacity) is changeable. In the present embodiment, the regenerative hydraulic motor 8 is a swash plate hydraulic motor. The tilting angle of the regenerative hydraulic motor 8 is adjusted by a regenerative hydraulic motor regulator 82. A replenishment line 56 is connected to the regenerative line 55. When the hydraulic oil supplied to the regenerative hydraulic motor 8 through the regenerative line 55 is insufficient, the hydraulic oil is supplied from the tank 21 to the regenerative hydraulic motor 8 through the replenishment line 56. The replenishment line 56 is provided with a check valve 57, which prevents a reverse flow of the hydraulic oil to the tank 21.

Similar to Embodiment 1, the regenerative line 55 is provided with the pressure sensor 71, which detects the pressure Pr of the regenerative line 55. The regenerative hydraulic motor regulator 82 is controlled by the controller 7 based on the pressure Pr of the regenerative line 55 detected by the pressure sensor 71. The regenerative hydraulic motor regulator 82 may operate on hydraulic pressure, or may operate on electrical signals. In a case where the regenerative hydraulic motor regulator 82 operates on hydraulic pressure, the regenerative hydraulic motor regulator 82 is controlled by the controller 7 via a solenoid proportional valve (not shown) connected to the regenerative hydraulic motor regulator 82.

As described above, in the hydraulic drive system 1F of the present embodiment, when the flow rate Qr of the hydraulic oil flowing through the regenerative line 55 at the time of boom lowering operation (in the present embodiment, the flow rate of the hydraulic oil discharged from the boom cylinder 11) is sufficient, the hydraulic oil whose pressure is kept to the setting pressure of the relief valve 62 is led to the regenerative hydraulic motor 8, and thereby the driving of the first main pump 14 and the second main pump 16 is assisted. This makes it possible to regenerate energy derived from boom lowering. In addition, the energy regeneration can be performed with the regenerative line 55, the regenerative hydraulic motor 8, and the relief valve 62, i.e., with a simple configuration. This makes it possible to realize a highly reliable system at low cost.

When the discharge flow rate Qr from the boom cylinder 11 at the time of boom lowering operation is higher than or equal to a passing flow rate Qm of the regenerative hydraulic motor 8, the pressure Pr of the regenerative line 55 is the setting pressure Pc of the relief valve 62. However, the pressure Pr of the regenerative line 55 decreases therefrom when the discharge flow rate Qr from the boom cylinder 11 at the time of boom lowering operation is lower than the passing flow rate Qm of the regenerative hydraulic motor 8. Since the pressure Pr of the regenerative line 55 is substantially equal to the pressure at the meter-out outlet of the boom control valve 3, if no measure is taken against such decrease in the pressure Pr of the regenerative line 55, the operation feeling relating to boom lowering may vary. The present embodiment adopts a configuration that prevents the operation feeling relating to boom lowering from varying even when the pressure Pr of the regenerative line 55 decreases.

Specifically, the controller 7 controls the regenerative hydraulic motor regulator 82, such that the pressure Pr of the regenerative line 55 detected by the pressure sensor 71 is kept to the setting pressure Pc of the relief valve 62 at the time of boom lowering operation. This makes it possible to obtain the same operation feeling relating to boom lowering regardless of the flow rate Qr of the hydraulic oil discharged from the boom cylinder 11.

<Variations>

In order to obtain the same operation feeling relating to boom lowering regardless of the flow rate Qr of the hydraulic oil discharged from the boom cylinder 11, a configuration similar to that described in Embodiment 2 may be adopted instead of controlling the regenerative hydraulic motor regulator 82. Specifically, as shown in FIG. 3, the boom lowering pilot line 32 may be provided with the solenoid proportional valve 44, and the solenoid proportional valve 44 may be controlled in the same manner as described in Embodiment 2. Alternatively, the control of the regenerative hydraulic motor regulator 82 and the control of the solenoid proportional valve 44 may be combined.

### Embodiment 7

Next, a hydraulic drive system 1G of a construction machine according to Embodiment 7 of the present invention is described with reference to FIG. 1G. The hydraulic drive system 1G of the present embodiment is different from the hydraulic drive system 1F of Embodiment 6 in that, in the hydraulic drive system 1G, the regenerative line 55 is provided with a regenerative switching valve 58. A tank line 59 is connected to the regenerative switching valve 58.

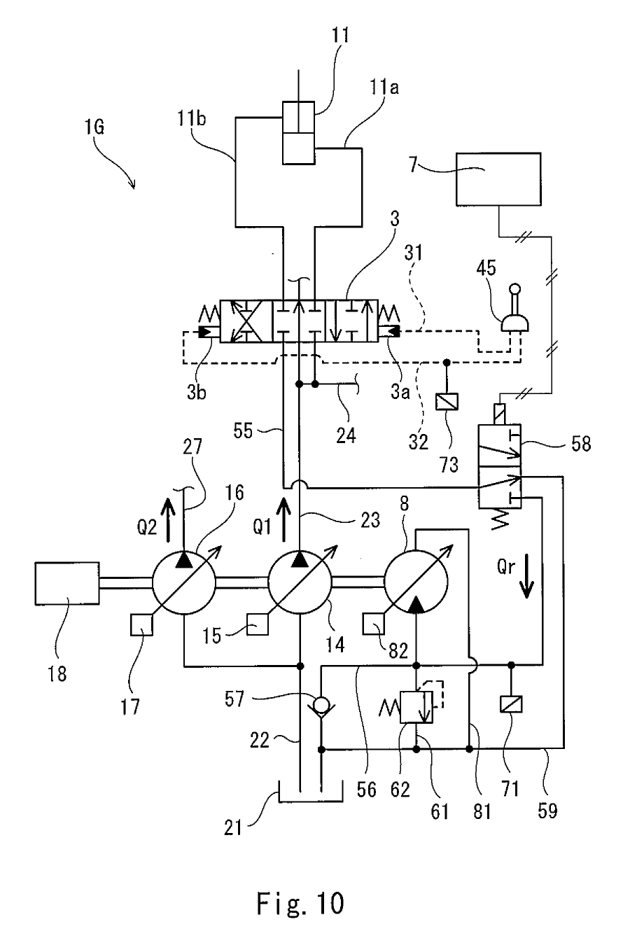

The regenerative switching valve 58 is intended for switching whether or not to allow the hydraulic oil that is discharged from the boom cylinder 11 at the time of boom lowering operation to flow into the regenerative hydraulic motor 8 through the regenerative line 55. Specifically, the regenerative switching valve 58 shifts between a non-regenerative position (lower position in FIG. 10) and a regenerative position (upper position in FIG. 10). When the regenerative switching valve 58 is in the non-regenerative position, the regenerative switching valve 58 brings the upstream portion of the regenerative line 55 into communication with the tank line 59. When the regenerative switching valve 58 is in the regenerative position, the regenerative switching valve 58 brings the upstream portion of the regenerative line 55 into communication with the downstream portion of the regenerative line 55.

The regenerative switching valve 58 may be an on-off valve that instantaneously switches its position from the non-regenerative position to the regenerative position or from the regenerative position to the non-regenerative position. However, as an alternative, the regenerative switching valve 58 may be such a variable throttle valve that at least when the variable throttle valve switches its position from the non-regenerative position to the regenerative position, the degree of communication between the upstream portion of the regenerative line 55 and the tank line 59 gradually decreases, and the degree of communication between the upstream portion of the regenerative line 55 and the downstream portion of the regenerative line 55 gradually increases. The regenerative switching valve 58 need not be a single valve, but may be configured as a pair of on-off valves or a pair of variable throttle valves.

The regenerative switching valve 58 is controlled by the controller 7 based on the second operation signal Sb (in the present embodiment, the second pilot pressure) outputted from the boom operation device 45. In the present embodiment, when the second operation signal Sb is outputted from the boom operation device 45, the controller 7 switches the regenerative switching valve 58 to the regenerative position, and when the second operation signal Sb is not outputted from the boom operation device 45, the controller 7 keeps the regenerative switching valve 58 in the non-regenerative position. By moving the regenerative switching valve 58 in this manner, the hydraulic oil discharged from the boom cylinder 11 at the time of boom raising operation does not flow into the tank 21 through the tank line 59, and thus unnecessary pressure is not generated. Therefore, in the hydraulic drive system 1G, in which energy derived from boom lowering is regenerated, loss of pump driving force at the time of boom raising operation is small.

In addition, the present embodiment makes it possible to select whether or not to perform energy regeneration at the time of boom lowering operation.

### Embodiment 8

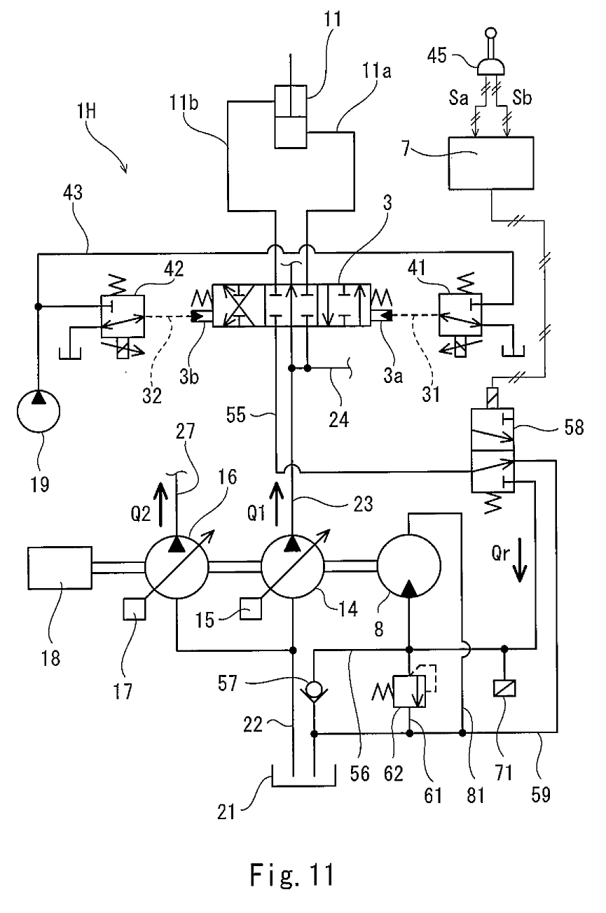

Next, a hydraulic drive system 1H of a construction machine according to Embodiment 8 of the present invention is described with reference to FIG. 11. The hydraulic drive system 1G of the present embodiment is different from the hydraulic drive system 1G of Embodiment 7 in the following points: in the hydraulic drive system 1H, the boom operation device 45 is the electrical joystick described in Embodiment 3; the first and the second solenoid proportional valves 41 and 42 are connected to the first and the second pilot ports 3a and 3b of the boom control valve 3, respectively; and the regenerative hydraulic motor 8 is a fixed displacement motor.

In a case where the pressure Pr of the regenerative line 55 detected by the pressure sensor 71 is lower than the setting pressure Pc of the relief valve 62 at the time of boom lowering operation, the controller 7 controls the second solenoid proportional valve 42 such that, as shown in FIG. 4, the meter-out opening area of the boom control valve 3 is smaller than the meter-out opening area in a case where the pressure Pr of the regenerative line 55 detected by the pressure sensor 71 is the setting pressure Pc of the relief valve 62. To be more specific, as shown in FIG. 6, in the case of Pr<Pc, the controller 7 decreases the command current I fed to the second solenoid proportional valve 42 to be less than in the case of Pr=Pc. Accordingly, the stroke of the spool of the boom control valve 3 in the case of Pr<Pc is more restricted than in the case of Pr=Pc, and the meter-out opening area in the ease of Pr<Pc is smaller than in the case of Pr=Pc.

As described above, when the pressure Pr of the regenerative line 55 decreases, the meter-out opening area of the boom control valve 3 is reduced. This makes it possible to obtain the same operation feeling relating to boom lowering regardless of the flow rate Qr of the hydraulic oil discharged from the boom cylinder 11. It should be noted that in a case where the regenerative hydraulic motor 8 is of a variable displacement type, the control of the present embodiment may be combined with the control of the regenerative hydraulic motor regulator 82 of Embodiment 6.

### Other Embodiments

The present invention is not limited to the above-described Embodiments 1 to 8. Various modifications can be made without departing from the spirit of the present invention. For example, in Embodiments 1 to 8, the hydraulic oil discharged from the turning motor at the time of turning deceleration operation may be led to the regenerative line (51 or 55) to regenerate energy derived from turning deceleration.

In Embodiments 7 and 8, the regenerative switching valve 58 may be eliminated, and instead, the boom raising supply line 11a may be provided with the regenerative switching valve 52A as shown in FIG. 8, and the regenerative line 55 may be connected to the regenerative switching valve 52A. In this case, similar to FIG. 8, the tank line 29 is connected to the boom control valve 3.

### REFERENCE SIGNS LIST

1A to 1H hydraulic drive system

10 construction machine

11 boom cylinder

11a boom raising supply line

11b boom lowering supply line

14 first main pump (first pump)

16 second main pump (second pump)

18 engine

21 tank

22, 26 suction line

23, 27 circulation line

25, 28 check valve

3 boom control valve

3a first pilot port

3b second pilot port

41, 42, 44 solenoid proportional valve

45 boom operation device

51, 55 regenerative line

52, 52A, 58 regenerative switching valve

61 relief line

62 relief valve

7 controller

71, 73 pressure sensor

8 regenerative hydraulic motor

82 regenerative hydraulic motor regulator

1. A hydraulic drive system of a construction machine, the hydraulic drive system comprising:
a first pump and a second pump that are driven by an engine;
a boom control valve that is disposed on a circulation line extending from the first pump and that is connected to a boom cylinder by a boom raising supply line and a boom lowering supply line;
a first suction line that leads hydraulic oil from a tank to the first pump;
a second suction line that leads the hydraulic oil from the tank to the second pump;
a regenerative line, through which the hydraulic oil discharged from the boom cylinder flows, the regenerative line extending from the boom control valve or the boom raising supply line and being connected to at least one of the first and the second suction lines;
a check valve provided on the first suction line and/or the second suction line, the check valve being positioned upstream of where the regenerative line is connected to the first suction line and/or the second suction line; and
a relief valve provided on a relief line that communicates with the regenerative line.

2. The hydraulic drive system of a construction machine according to claim 1, comprising a regenerative switching valve that switches whether or not to allow the hydraulic oil that is discharged from the boom cylinder at a time of boom lowering operation to flow into the first suction line and/or the second suction line through the regenerative line.

3. A hydraulic drive system of a construction machine, the hydraulic drive system comprising:
a pump driven by an engine;
a boom control valve that is disposed on a circulation line extending from the pump and that is connected to a boom cylinder by a boom raising supply line and a boom lowering supply line;
a suction line that leads hydraulic oil from a tank to the pump;
a regenerative line, through which the hydraulic oil discharged from the boom cylinder flows, the regenerative line extending from the boom control valve or the boom raising supply line and being connected to the suction line;
a check valve provided on the suction line and positioned upstream of where the regenerative line is connected to the suction line; and
a relief valve provided on a relief line that communicates with the regenerative line.

4. The hydraulic drive system of a construction machine according to claim 3, comprising a regenerative switching valve that switches whether or not to allow the hydraulic oil that is discharged from the boom cylinder at a time of boom lowering operation to flow into the suction line through the regenerative line.

5. The hydraulic drive system of a construction machine according to claim 1 wherein
the boom control valve includes a first pilot port for boom raising operation and a second pilot port for boom lowering operation,
the hydraulic drive system comprises:
a solenoid proportional valve that outputs a secondary pressure to the second pilot port;
a pressure sensor that detects a pressure of the regenerative line; and
a controller that feeds a command current to the solenoid proportional valve,
the regenerative line is connected to the boom control valve, and
in a case where the pressure detected by the pressure sensor is lower than a setting pressure of the relief valve at a time of boom lowering operation, the controller controls the solenoid proportional valve, such that a meter-out opening area of the boom control valve is smaller than the meter-out opening area in a case where the pressure detected by the pressure sensor is the setting pressure of the relief valve.

6. A hydraulic drive system of a construction machine, the hydraulic drive system comprising:
a pump driven by an engine;
a regenerative hydraulic motor coupled to the pump;
a boom control valve that is disposed on a circulation line extending from the pump and that controls supply and discharge of hydraulic oil to and from a boom cylinder;
a regenerative line that leads the hydraulic oil discharged from the boom cylinder to the regenerative hydraulic motor; and
a relief valve provided on a relief line that communicates with the regenerative line.

7. The hydraulic drive system of a construction machine according to claim 6, comprising a regenerative switching valve that switches whether or not to allow the hydraulic oil that is discharged from the boom cylinder at a time of boom lowering operation to flow into the regenerative hydraulic motor through the regenerative line.

8. The hydraulic drive system of a construction machine according to claim 6, wherein
the boom control valve includes a first pilot port for boom raising operation and a second pilot port for boom lowering operation,
the hydraulic drive system comprises:
a solenoid proportional valve that outputs a secondary pressure to the second pilot port;
a pressure sensor that detects a pressure of the regenerative line; and
a controller that feeds a command current to the solenoid proportional valve,
the regenerative line is connected to the boom control valve, and
in a case where the pressure detected by the pressure sensor is lower than a setting pressure of the relief valve at a time of boom lowering operation, the controller controls the solenoid proportional valve, such that a meter-out opening area of the boom control valve is smaller than the meter-out opening area in a case where the pressure detected by the pressure sensor is the setting pressure of the relief valve.

9. The hydraulic drive system of a construction machine according to claim 6, wherein
the regenerative hydraulic motor is a variable displacement motor whose tilting angle is changeable,
the regenerative line is connected to the boom control valve, and
the hydraulic drive system comprises:
a regenerative hydraulic motor regulator that adjusts the tilting angle of the regenerative hydraulic motor;
a pressure sensor that detects a pressure of the regenerative line; and
a controller that controls the regenerative hydraulic motor regulator, such that the pressure detected by the pressure sensor is kept to a setting pressure of the relief valve at a time of boom lowering operation.

10. The hydraulic drive system of a construction machine according to claim 3, wherein
the boom control valve includes a first pilot port for boom raising operation and a second pilot port for boom lowering operation,
the hydraulic drive system comprises:
a solenoid proportional valve that outputs a secondary pressure to the second pilot port;
a pressure sensor that detects a pressure of the regenerative line; and
a controller that feeds a command current to the solenoid proportional valve,
the regenerative line is connected to the boom control valve, and
in a case where the pressure detected by the pressure sensor is lower than a setting pressure of the relief valve at a time of boom lowering operation, the controller controls the solenoid proportional valve, such that a meter-out opening area of the boom control valve is smaller than the meter-out opening area in a case where the pressure detected by the pressure sensor is the setting pressure of the relief valve.
